(19) United States
(12) Patent Application Publication
(10) Pub. No.: US 2006/0290511 A1
(43) Pub. Date: Dec. 28, 2006

(54) Methods and systems for in-line RFID transponder assembly

(76) Inventor: Kenneth Shanton, West Chicago, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/158,402

(22) Filed: Jun. 22, 2005

(51) Int. Cl. G08B 13/14

(52) U.S. Cl. 340/572.7

(57) ABSTRACT

Methods and apparatus for manufacturing corrugated paperboard are provided. The apparatus includes a linerboard feed device configured to supply a quantity of linerboard including a plurality of antennae coupled to a first planar surface of the linerboard, an optical sensor configured to locate a connection area of the plurality of antennae, and an attach mechanism configured to couple a radio frequency identification circuit to the connection area.

### BACKGROUND OF THE INVENTION

This invention relates generally to wireless communication systems and, more particularly, to container structures that incorporate radio frequency identification (RFID) components.

At least some known RFID systems include a transponder, an antenna, and a transceiver with a decoder, or a reader. The transponder typically includes a radio frequency integrated circuit, and an antenna positioned on a substrate, such as an inlet or tag. The antenna receives RF energy from the reader wirelessly and transmits the data encoded in the received RF energy to the radio frequency integrated circuit.

RF transponder “readers” utilize an antenna as well as a transceiver and decoder. When a transponder passes through an electromagnetic zone of a reader, the transponder is activated by the signal from the antenna. The reader decodes the data on the transponder and this decoded information is forwarded to a host computer for processing. Readers or interrogators can be fixed, mobile or handheld devices, depending on the particular application.

Several different types of transponders are utilized in RFID systems, including passive, semi-passive, and active transponders. Each type of transponder may be read only or read/write capable. Passive transponders obtain operating power from the radio frequency signal of the reader that interrogates the transponder. Semi-passive and active transponders are powered by a battery, which generally results in a greater read range. At least some known semi-passive transponders operate on a timer and periodically transmit information to the reader. Transponders are also activated when they are read or interrogated by a reader. Active transponders are capable of initiating communication with a reader, whereas passive and semi-passive transponders are activated only when they are read by another device first. When multiple transponders are located in a radio frequency field, each transponder may be read individually or multiple transponders may be read substantially simultaneously. Additionally, in various embodiments, one or more environmental sensors are coupled to the transponders to sense environmental conditions, such as temperature, pressure, humidity, vibration, and shock. The status of the environmental condition is then communicated to the reader.

Transponders typically are attached to an article, such as a corrugated box or a folding carton, in the form of a smart label or tag that includes a radio frequency integrated circuit, an antenna, and a backing substrate, usually polyester or paper, together with a release layer. The assembled label is then attached to the article by means of a pressure-sensitive adhesive that is incorporated into the label. However, such a process is not cost-effective for the mass application of RFID transponders to a large quantity of articles in a global supply chain.

### BRIEF DESCRIPTION OF THE INVENTION

In one embodiment, an apparatus for manufacturing corrugated paperboard is provided. The apparatus includes a linerboard feed device configured to supply a quantity of linerboard including a plurality of antennae coupled to a first planar surface of the linerboard, an optical sensor configured to locate a connection area of the plurality of antennae, and an attach mechanism configured to couple a radio frequency identification circuit to the connection area.

In another embodiment, a corrugate machine for manufacturing radio frequency identification enabled corrugated paperboard is provided. The machine includes a press configured to couple a plurality of antennae to a first planar surface of supply of linerboard, a corrugator configured to corrugate a quantity of corrugating material stock into a corrugated medium, a double facer configured to join the corrugated medium to the linerboard on a side of the linerboard opposite the first planar surface to form a corrugated structure, an optical sensor configured to locate a connection area of the plurality of antennae, and an attach mechanism configured to couple a radio frequency identification circuit to the connection area.

In yet another embodiment, a method of forming a corrugated panel is provided. The method includes providing a plurality of antennae on a quantity of linerboard, the antennae printed using a conductive ink, optically locating an antenna connection area, and coupling a radio frequency identification circuit to the antenna connection area such that radio frequency energy received by the antenna is transmitted to the radio frequency identification circuit.

### BRIEF DESCRIPTION OF THE DRAWINGS

FIG. 1 is a schematic view of an exemplary printing press that may be used to print RFID antennae on linerboard;

FIG. 2 is a schematic view of an exemplary RF enabled strap that may be used with the linerboard and antennae shown in FIG. 1;

FIG. 3 is a schematic view of an exemplary corrugate machine that may be used to apply radio frequency identification enabled straps to the linerboard shown in FIG. 1; and

FIG. 4 is a flowchart of an exemplary method 400 of forming a corrugated panel.

### DETAILED DESCRIPTION OF THE INVENTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

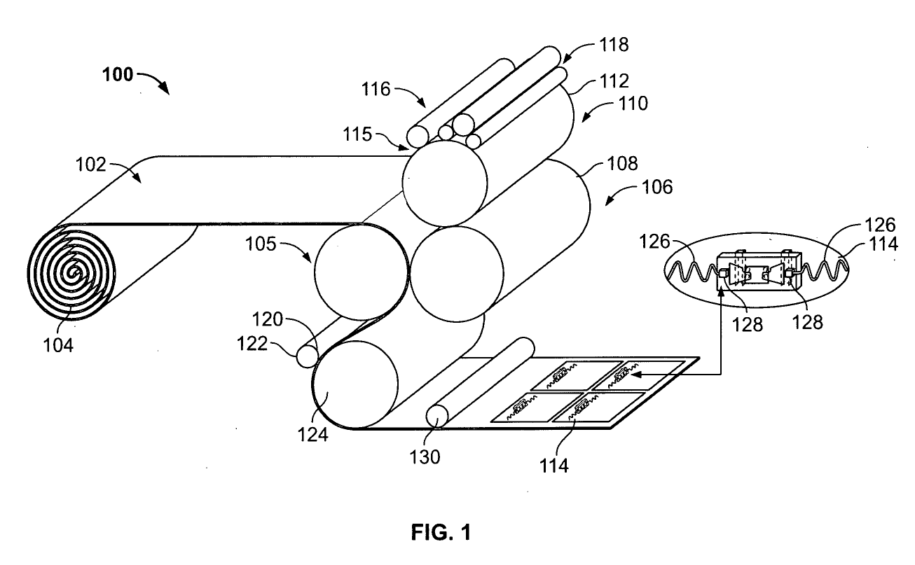

FIG. 1 is a schematic view of an exemplary printing press 100 that may be used to print RFID antennae on linerboard. Press 100 may use any print process capable of performing the functions described herein. In the exemplary embodiment, press 100 receives a supply of linerboard 102 continuously from a web roll 104. Linerboard 102 then passes between an impression cylinder 105 and a blanket cylinder 106 that includes a thick rubber sheet or blanket 108 that transfers ink from a plate cylinder 110 to linerboard 102. In at least one type of printing, for example, in gravure printing, a similar rubber sheet covers impression cylinder 105. Impression cylinder 105 is configured to press linerboard 102 against blanket 108 in an offset printing configuration or against a plate 112 in a gravure printing configuration. Plate cylinder 110 includes at least one plate 112 fixed to an outer peripheral surface thereof. In the exemplary embodiment, plate 112 includes an image of an antenna 114 formed by photo-mechanically transferring the image from a film (not shown).

Press 100 includes a source of fountain solution 115 that, in the exemplary embodiment, includes a mixture of water and chemicals, the mixture dampens printing plate 112 to facilitate preventing ink from adhering to a non-image area on a surface of plate 112. In the exemplary embodiment, one or more dampening rollers 116 are used to facilitate even distribution and a proper amount of fountain solution 115 along the surface of plate 112. In addition, one or more ink rollers 118 are used to apply a supply of ink to plate 112. A supply of over-print varnish 120 is applied to linerboard 102 after the transfer of the antenna image to linerboard 102 using a varnish roller 122 and a web transfer cylinder 124. Antenna 114 includes one or more reception areas 126 and one or more connection areas 128. A single reception area includes a predetermined pattern of conductive material extending between reception areas 126. An embossing device 130 is used to create a depression in linerboard 102 at connection area 128. Alternatively, an embossed depression is formed with the raw linerboard stock or is formed as part of the process of printing antenna 114.

In operation, fountain solution 115 is applied to plate 112 as plate cylinder 110 is rotating. Dampening rollers 116 maintain a predetermined pressure along a surface of plate 112 to spread fountain solution 115 to a predetermined location and depth along plate 112. Ink rollers 118 apply a predetermined selectable quantity of ink to the printing image area of plate 112. The ink image is then transferred to blanket 108 rotating with blanket cylinder 106. The ink image is then transferred to linerboard 102, which is being fed continuously through press 100 between impression cylinder 105 and blanket cylinder 106. In the exemplary embodiment, antenna 114 is printed using a conductive ink, such as an ink that includes a metallic and/or conducting polymeric component. Antenna 114 is printed under graphics printed on linerboard 102, over the graphics, or printed in conjunction with other print processes that print graphics on linerboard 102. In the exemplary embodiment, heat is added to linerboard 102 at any point to dry and/or cure the ink. An over print varnish (OPV) is applied to antenna 114 such that connection area 128 remains uncovered. In an alternative embodiment, no OPV is used. Linerboard 102 is wound on a take-up roll (not shown) when a downstream process is not available to process the linerboard or when off-line printing is used to supply linerboard to a production facility in an off-line print application. In the exemplary embodiment, linerboard 102 is fed directly to another downstream machine in an in-line process.

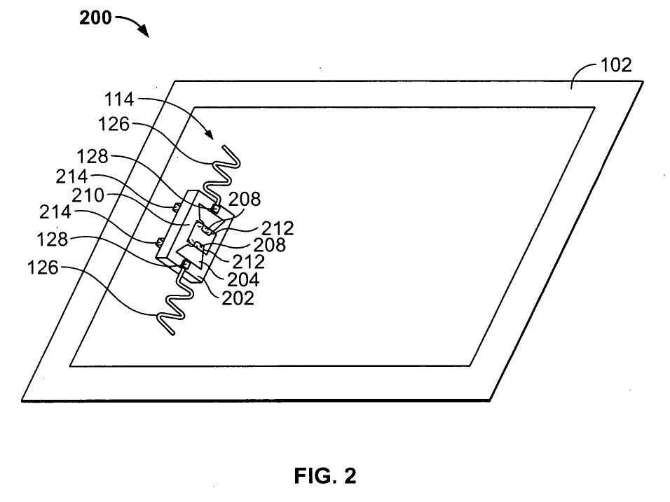

FIG. 2 is a schematic view of an exemplary RF enabled strap 200 that may be used with linerboard 102 and antenna 114 (shown in FIG. 1). In the exemplary embodiment, strap 200 includes a substrate 202, an electrically conductive pad 204 that is printed on substrate 202 using a conductive ink. A radio frequency identification circuit 206 is electrically coupled to pad 204 through one or more bumps 208 extending away from a surface 210 of radio frequency identification circuit 206. Radio frequency identification circuit 206 is coupled to substrate 202 using an adhesive 212, such as a conductive or anisotropic epoxy or other adhesive material. An adhesive 214 is applied to assembled strap 200 to facilitate coupling strap 200 to antenna 114.

In the exemplary embodiment, radio frequency identification circuit 206 is a passive circuit. In various alternative embodiments, radio frequency identification circuit 206 is a semi-passive or active circuit that includes a battery (not shown) or capacitive storage device coupled to radio frequency identification circuit 206. A sensor (not shown) is electrically coupled to radio frequency identification circuit 206 for communicating environmental data proximate the sensor. The sensor is of micro-mechanical design such that the sensor is incorporated into radio frequency identification circuit 206 or is a separate device that is communicatively coupled to radio frequency identification circuit 206. The sensor is used to read an environmental or other condition in the vicinity of the sensor, for example, but not limited to, vibration, shock, temperature, pressure, and humidity. In an alternative embodiment, a plurality of sensors is coupled to each radio frequency identification circuit 206. In one embodiment, the sensor is configured to read and transmit a signal corresponding to the environmental conditions when signaled by an RF reader. In various alternative embodiments, the sensors include a battery which permits the sensor to read and record the environmental conditions and transmit the recorded data when requested or interrogated by an RF reader.

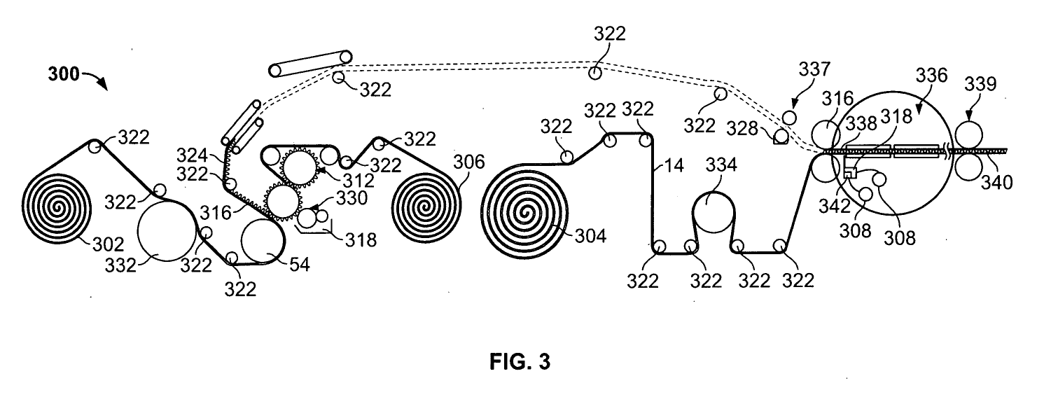

FIG. 3 is a schematic view of an exemplary corrugate machine 300 that may be used to apply radio frequency identification enabled straps 200 to linerboard 102. Corrugate machine 300 includes a supply of a first linerboard 302, a supply of a second linerboard 304, a supply of a corrugating material stock 306, and a supply 308 of RF identification enabled straps 200. In the exemplary embodiment, straps 200 include a second substrate or web 310 having an adhesive release layer (not shown) coupled to web 310 such that straps 200 are handled collectively on a roll or fan-fold form and removed individually from web 310 for application to linerboard 102. Corrugate machine 300 includes a corrugator 312, a single facer 314, a double facer 316, a strap attach device 318, and a cutter 339. A plurality of idler rollers 322 are positioned at predetermined locations along a path of linerboard 102 to provide a predetermined amount of tension on linerboard 102 to facilitate movement of linerboard 102 through corrugate machine 300. The embossed depression is sized to house radio frequency identification circuit 206 at least partially within the depression. Applying straps 200 such that radio frequency identification circuit 206 is within a depression facilitates protecting radio frequency identification circuit 206 during fabrication and during subsequent packaging and shipping operations.

During operation, corrugating material stock 306 is fed into corrugator 312, which corrugates the corrugating material stock 306 into a corrugated medium 324 having a plurality of flutes 326. The corrugator 312 is positioned downstream from the supply of corrugating material stock 306. An adhesive 328 is applied to the flutes 326 of the corrugated medium 324 by an adhesive applicator 330 after the corrugating material stock 306 is corrugated. Linerboard 302 moves in proximity to a pre-heater 332 and corrugated medium 324 is then joined to linerboard 302 by single facer 314. Second linerboard 304 is fed through a second pre-heater 334, and is then joined to the corrugated medium 324 and first linerboard 302 at double facer 316. Prior to entering the double facer 316, adhesive 328 is applied to flutes 326 of the corrugated medium 324 by a second adhesive applicator 337. Adhesive 328 joins second linerboard 304 to corrugated medium 324 in double facer 316 to form a corrugated structure 338. Corrugated structure 338 is then fed into a dryer 336, which dries adhesive 328 and facilitates curing antenna 114, adhesive 214, and/or adhesive 212. Corrugated structure 338 is then cut by a cutter 339 to form a plurality of blanks 340.

The RF components are applied to corrugated structure 338 at a plurality of different positions. A strap attach device 318 is used to apply strap 200 to an outside surface of corrugated structure 338. In the exemplary embodiment, strap attach device 318 is illustrated in a position downstream from double facer 316. In various alternative embodiments, strap attach device 318 is positioned in other locations.

In the exemplary embodiment, strap attach device 318 includes a registration mechanism 342 for locating antenna 114 such that strap attach device 318 applies each strap 200 to a predetermined location on connection area 128. In the exemplary embodiment, registration mechanism 342 includes an optical device, for example an electric eye or video camera that detects each connection area 128 prior to connection area 128 passing strap attach device 318.

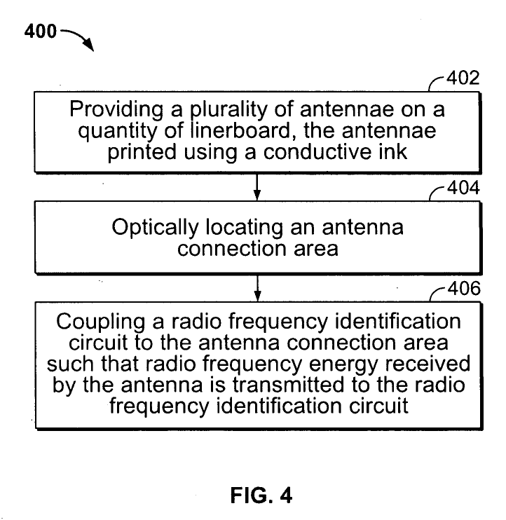

FIG. 4 is a flowchart of an exemplary method 400 of forming a corrugated panel, including RF enabled components, for supply chain packaging materials. Method 400 includes providing 402 a plurality of antennae on a quantity of linerboard, the antennae printed using a conductive ink. In the exemplary embodiment, a preprint printing press or other off-line printing press upstream of the corrugator is used. Ink used to print the antennae is electrically conductive, for example, ink that incorporates metals, such as copper, aluminum and/or silver. In an alternative embodiment, inks incorporating organic conducting polymers are used. The antenna is printed using a lithographic or flexographic press, but any suitable printing technology can be used, such as rotogravure, rotary screen printing, ink jet printing, and pad printing. One or more conductive layers are printed if a thicker antenna is desired. Alternatively, a non-conductive primer layer can be used prior to printing the conductive ink. In various alternative embodiments, non-conductive (dielectric) layers are interposed between the conductive layers. The conductive antenna could also be sprayed onto the substrate, using a mask to define the shape of the antenna. Additionally, in alternative embodiments, drop-on-demand inkjet technology or continuous inkjet technology are used to apply the conductive ink, or the antenna is transferred from a release substrate by pressure and/or by thermal transfer.

In the exemplary embodiment, the linerboard is, for example, clay-coated high-holdout linerboard. In an alternative embodiment, regular linerboard is used. The quality of the printed antenna varies according to the linerboard or substrate used and the printing technology employed. Applying the conductive antenna on linerboard upstream from the corrugator facilitates obtaining a uniform print. After the linerboard has been combined with corrugating medium in the corrugator, it is more difficult to ensure a uniform ink laydown due to variations of absorbency due to a “washboarding” effect that occurs in the corrugator.

In the exemplary embodiment, the antenna is applied by strap attach. In an alternative embodiment, direct chip attach is used and a heat resistant overprint varnish (OPV) is applied over the printed antenna. A windowing application of the OPV that leaves the connection area uncovered facilitates making a reliable electrical contact between the antenna and the radio frequency identification circuit. The OPV may, for example, protect the printed antenna from damage as it passes through the drying section of the corrugator, enable the conductive ink to “cure”, and protect the antenna from damage during the remaining converting and other operations expected to occur in the supply chain. At least some known inks require exposure to temperatures of at least 150° C. to enable the full conductive properties to be obtained. An antenna passing through a corrugator is exposed to temperatures of approximately 180-200° C. in the corrugator drying section. Additionally, the OPV may provide antistatic protection to the strap components using antistatic additives incorporated into the OPV composition. Alternatively, a film patch is used in place of the OPV. When existing process heat sources are unavailable and/or inadequate for curing the printing ink, or other curing methods are required, for example, ultraviolet (UV) or electron beam (EB), additional heat sources, and additional equipment are added to the printing press and or corrugate machine.

The connection area of each antenna is optically located 404 using a sensor, for example, an electric eye or a video camera. A controller communicatively coupled to the optical sensor processes the image of the antenna as the linerboard passes proximate the optical sensor to detect features of the antenna that are characteristic to the connection area. The controller then indexes the strap attach device such that the strap or radio frequency identification circuit chip are coupled 406 to the antenna at a predetermined location with respect to the connection area. The strap or radio frequency identification circuit chip is coupled 406 to the antenna connection area such that radio frequency energy received by the antenna is transmitted to the radio frequency identification circuit.

Although the embodiments described herein are discussed with respect to supply chain packaging material, it is understood that the RF-enabled component assembly and processing methodology described herein is not limited to supply chain packaging applications, but may be utilized in other non-packaging applications.

It will be appreciated that the use of first and second or other similar nomenclature for denoting similar items is not intended to specify or imply any particular order unless otherwise stated.

The above-described embodiments of an in-line RFID transponder assembly system provide a cost-effective and reliable means for mass production speed assembly of RF identification enabled packaging material. More specifically, preprinting RFID antennas to linerboard and applying RFID straps to the antennae during fabrication of corrugated structures permits high speed production of supply chain packaging with RFID components applied during fabrication. As a result, the described methods and systems facilitate in-line RFID transponder assembly in a cost-effective and reliable manner.

Exemplary embodiments of in-line RFID transponder assembly methods and apparatus are described above in detail. The in-line RFID transponder assembly components illustrated are not limited to the specific embodiments described herein, but rather, components of each imaging system may be utilized independently and separately from other components described herein. For example, the in-line RFID transponder assembly components described above may also be used in combination with different in-line RFID transponder assembly components. A technical effect of the various embodiments of the systems and methods described herein include facilitating assembly of RF enabled packaging materials at production level speeds.

While the invention has been described in terms of various specific embodiments, those skilled in the art will recognize that the invention can be practiced with modification within the spirit and scope of the claims.

What is claimed is:

1. An apparatus for manufacturing corrugated paperboard, said apparatus comprising:
a linerboard feed device configured to supply a quantity of linerboard including a plurality of antennae coupled to a first planar surface of the linerboard;
an optical sensor configured to locate a connection area of the plurality of antennae; and
an attach mechanism configured to couple a radio frequency identification circuit to the connection area.

2. An apparatus in accordance with claim 1 further comprising:
a corrugator configured to corrugate a quantity of corrugating material stock into a corrugated medium; and
a double facer configured to join the corrugated medium to the linerboard on a side of the linerboard opposite the first planar surface to form a corrugated structure.

3. An apparatus in accordance with claim 1 further comprising a printing press configured to couple the plurality of antennae to the linerboard using at least one of a lithographic process, a flexographic process, a rotogravure process, a rotary screen print process, a drop-on-demand ink jet process, a continuous ink jet process, a spray process, a pad printing process, a pressure release substrate process, and a thermal transfer process.

4. A corrugate machine for manufacturing radio frequency identification enabled corrugated paperboard comprising:
a press configured to couple a plurality of antennae to a first planar surface of supply of linerboard;
a corrugator configured to corrugate a quantity of corrugating material stock into a corrugated medium;
a double facer configured to join the corrugated medium to the linerboard on a side of the linerboard opposite the first planar surface to form a corrugated structure;
an optical sensor configured to locate a connection area of the plurality of antennae; and
an attach mechanism configured to couple a radio frequency identification circuit to the connection area.

5. A corrugate machine in accordance with claim 4 wherein the press is configured to print the plurality of antennae using at least one of a lithographic process, a flexographic process, a rotogravure process, a rotary screen print process, a drop-on-demand ink jet process, a continuous ink jet process, a spray process, a pad printing process, a pressure release substrate process, and a thermal transfer process;

6. A corrugate machine in accordance with claim 4 wherein the press is configured to print the plurality of antennae using a conductive ink comprising at least one of copper, aluminum, silver, and organic conducting polymers.

7. A corrugate machine in accordance with claim 4 wherein the press is configured to print the plurality of antennae using at least one of a plurality of layers of conductive ink, and a plurality of conductive ink layers and dielectric layers.

8. A corrugate machine in accordance with claim 4 wherein the attach mechanism is located downstream from the double facer.

9. A method of forming a corrugated panel comprising:
providing a plurality of antennae on a quantity of linerboard, the antennae printed using a conductive ink;
optically locating an antenna connection area; and
coupling a radio frequency identification circuit to the antenna connection area such that radio frequency energy received by the antenna is transmitted to the radio frequency identification circuit.

10. A method in accordance with claim 9 wherein providing a plurality of antennae comprises printing the plurality of antennae using a conductive ink.

11. A method in accordance with claim 10 wherein printing the plurality of antennae using a conductive ink comprises printing the plurality of antennae using a conductive ink that includes at least one of copper, aluminum, silver, and organic conducting polymers.

12. A method in accordance with claim 10 wherein printing the plurality of antennae using a conductive ink comprises printing the plurality of antennae using at least one of a lithographic process, a flexographic process, a rotogravure process, a rotary screen print process, a drop-on-demand ink jet process, a continuous ink jet process, a spray process, a pad printing process, a pressure release substrate process, and a thermal transfer process.

13. A method in accordance with claim 10 wherein printing the plurality of antennae using a conductive ink comprises printing the plurality of antennae using a plurality of layers of conductive ink.

14. A method in accordance with claim 10 wherein printing the plurality of antennae using a conductive ink comprises printing the plurality of antennae using a plurality of dielectric layers.

15. A method in accordance with claim 10 further comprising curing the conductive ink in a drying section of a corrugator.

16. A method in accordance with claim 9 wherein providing a plurality of antennae comprises pre-printing the plurality of antennae on the linerboard using an off-line print process.

17. A method in accordance with claim 9 wherein providing a plurality of antennae comprises providing the plurality of antennae upstream of a corrugator.

18. A method in accordance with claim 9 wherein providing a plurality of antennae comprises applying a heat resistant overprint varnish (OPV) over at least a portion of the antenna such that the connection area is not covered by the OPV.

19. A method in accordance with claim 9 wherein providing a plurality of antennae on a quantity of linerboard comprises providing a plurality of antennae on a side of the linerboard that is an external surface of the corrugated panel.

20. A method in accordance with claim 9 wherein coupling a radio frequency identification circuit to the antenna connection area comprises coupling a radio frequency identification circuit to the antenna connection area downstream from a double facer.

21. A method in accordance with claim 9 wherein coupling a radio frequency identification circuit to the antenna connection area comprises coupling the radio frequency identification circuit directly to a respective antenna connection area.

22. A method in accordance with claim 9 wherein coupling a radio frequency identification circuit to the antenna connection area comprises coupling the radio frequency identification circuit to the antenna connection area using a strap.
